(19) United States
(12) Patent Application Publication
(10) Pub. No.: US 2011/0295675 A1
(43) Pub. Date: Dec. 1, 2011

(54) LOYALTY PRESENTATION, METHOD AND SYSTEM

(76) Inventor: Robin Reodica, Singapore (SG)

(21) Appl. No.: 13/049,279

(22) Filed: Mar. 16, 2011

Related U.S. Application Data
(60) Provisional application No. 61/349,941, filed on May 31, 2010.

(51) Int. Cl. G06Q 30/00

(52) U.S. Cl. 705/14.34; 705/14.38

(57) ABSTRACT

Methods and systems are presented for sending an update to a customer's loyalty program account through a credit card authorization response message as well as sending the update by SMS, MMS, or other electronic message to the customer's mobile phone or device. The electronic message can allow the user to switch between the type of loyalty points to be accrued as well as offer coupons and other incentives for further purchase. Store returns can update loyalty points and result in update messages as well.

### CROSS-REFERENCES TO RELATED APPLICATIONS

This application claims the benefit of U.S. Provisional Application No. 61/349,941, filed May 31, 2010 (Attorney Docket No. 016222-065500US), which is hereby incorporated by reference in its entirety for all purposes.

### BACKGROUND

1. Field of the Art

Methods and systems are disclosed for managing customer loyalty accounts. Specifically, inserting customer loyalty point information in credit/debit card authorization messages from an issuer bank and sending an update to a customer's cellular phone or mobile device in conjunction with the authorization message is described.

2. Discussion of the Related Art

Customer loyalty programs, sometimes referred to as rewards programs, allow businesses to reward customers who return to their businesses. Rewards such as airline miles, hotel stays, rental car upgrades, reward credits, or other loyalty points are typically accrued each time a customer makes a purchase at a business that has such a program. Periodically, the customer is provided a statement of his or her point balance. If the customer accrues a certain amount of points, then he or she may trade them in to acquire further products or services. For example, after acquiring 25,000 frequent flier miles with an airline, a customer may trade in the miles for a vacation plane ticket on the airline.

In many loyalty programs, a merchant sponsors the program, signing up customers with accounts and issuing cards or other indicators of the accounts to the customers. The merchant, such as an airline, brands the cards, etc. with its own nomenclature and manages the points accrued and account balances.

Loyalty programs are prevalent in the travel and entertainment industries and are becoming more accepted in grocery, consumer electronics, and other retail industries. With more merchants creating their own loyalty programs, consumers have become inundated with offers for such programs. Many consumers do not sign up for new loyalty programs because they already are members of several loyalty programs. It can be difficult to keep track of all the loyalty programs with which one is a member, even if a statement is received once a month. Furthermore, all of the loyalty points acquired with all the different merchants becomes seen as less and less useful to consumers as more programs are joined. Points are worth something when there are enough of them accumulated; however, loyalty points typically cannot be transferred between account programs. Thus, it can be difficult for consumers to accumulate enough points in one account to ‘buy’ anything with the points.

In response to consumer demand, banks have instituted their own customer loyalty programs. There are less banks than merchants in general, and thus there are less bank loyalty programs for a consumer to join and track. Purchases made by a customer at one merchant, through a credit card issued by the bank, can acquire points that can be accumulated with points from a purchase at another merchant. Thus, the points can accumulate in one account, the bank's loyalty program account, faster for a consumer than if points were accumulated in separate merchant loyalty program accounts.

To service the banks, payment service providers, such as Visa, have set up programs to manage the customer loyalty programs for the banks. The loyalty accounts can be branded by the banks or by the service provider. Managing loyalty programs this way alleviates many of the problems a consumer has in belonging to too many customer loyalty programs. However, a customer may still have problems determining what he or she can buy with his points.

### BRIEF SUMMARY

Generally, methods and systems are presented for inserting loyalty point information in the same authorization response messages that are used for authorizing credit card or other payments. Loyalty points additions, subtractions, balances, amounts to reach another threshold or acquire a bonus item, and other information can be inserted in the authorization response messages, sent to the merchant, and printed on the consumer's receipt. Meanwhile, loyalty point information is also sent to the consumer's cellular phone or other mobile device. A customer can compare the points balances between the receipt and cell phone in order to verify his or her account balance.

Some embodiments' loyalty programs can incorporate different types of points. For example, a consumer can elect between earning frequent flier miles, reward credits, or cash back. In response to the loyalty point information message on his or her phone after a transaction, the consumer can elect a different type of points to earn in the future. Alternatively or in addition, a consumer can instantly be presented with a coupon or offer for an additional purchase using the points he or she has just accumulated. The consumer can select, on his or her mobile device in real-time, which coupon to accept and then turn around at the same store and tender the coupon for an additional purchase.

Returning merchandise can result in an updated loyalty account balance reflecting a decrease in the number of points accrued. Both the merchant and the consumer can be presented with this data, on the card reader or receipt, and mobile device, respectively, and further offers can be made.

Some embodiments of the present disclosure relate to a method of providing real-time loyalty balances to customers. The method includes receiving an authorization request message for a transaction with a customer, updating, using a processor operatively coupled with a memory, a loyalty program account to which the customer belongs based on the transaction, inserting an account balance of the customer's loyalty program account in an authorization response message for the transaction, sending, in response to the authorization request message, the authorization response message, and sending to a mobile device of the customer, in response to the authorization request message, an electronic message with the customer's loyalty program account balance.

Some embodiments of the present disclosure relate to a method of providing real-time loyalty balances to customers. The method includes determining a customer loyalty program account for a customer, sending an authorization request message for a customer transaction, the authorization request message including an identifier of the customer loyalty program account, receiving an authorization response message, the authorization response message indicating an updated account balance of the customer loyalty program account, printing on a receipt the customer loyalty program account balance, and sending to a mobile device of the customer, in response to receiving the authorization response message, an electronic message with the customer's loyalty program account balance.

Some embodiments of the present disclosure relate to a method of changing a type of consumer loyalty points. The method includes initiating a transaction with a merchant, the transaction updating a balance of a customer loyalty program account, receiving on a mobile device an electronic message indicating the balance of the customer loyalty program account, and selecting an active element in the electronic message to initiate a change in a type of customer loyalty points to be acquired in a next transaction.

The method can further include comparing a balance of the customer loyalty program account printed on the receipt with a balance of the customer loyalty program account in the electronic message and performing further action based on the comparison.

Other embodiments relate to machine-readable tangible storage media and computer systems that employ or store instructions for the methods described above.

A further understanding of the nature and the advantages of the embodiments disclosed and suggested herein may be realized by reference to the remaining portions of the specification and the attached drawings.

### BRIEF DESCRIPTION OF THE DRAWINGS

FIG. 1 illustrates an issuer-sponsored loyalty program and electronic messaging in accordance with an embodiment.

FIG. 2 illustrates a service provider-sponsored loyalty program and electronic messaging in accordance with an embodiment.

FIG. 3 illustrates an electronic message with information on further loyalty points needed in accordance with an embodiment.

FIG. 4 illustrates an electronic message with selections for other types of loyalty points in accordance with an embodiment.

FIG. 5 illustrates types of loyalty points in accordance with an embodiment.

FIG. 6 illustrates an electronic message with selections for a coupon offer in accordance with an embodiment.

FIG. 7 illustrates a coupon in response to a selection on the electronic message of FIG. 6.

FIG. 8 illustrates a comparison of a receipt and an electronic message in accordance with an embodiment.

FIG. 9 is a flowchart illustrating a process in accordance with an embodiment.

FIG. 10 is a flowchart illustrating a process in accordance with an embodiment.

FIG. 11 is a flowchart illustrating a process in accordance with an embodiment.

FIG. 12 shows a block diagram of an exemplary computer apparatus that can be used in some embodiments.

The figures will now be used to illustrate different embodiments in accordance with the invention. The figures are specific examples of embodiments and should not be interpreted as limiting embodiments, but rather exemplary forms and procedures.

### DETAILED DESCRIPTION

Generally, methods and systems are presented for updating consumers' loyalty program accounts, building, adding, appending, or otherwise inserting loyalty point information in the same authorization response messages that are used for authorizing credit card or other payment transactions, and sending the loyalty point information to the consumers' mobile devices in response to transactions. Loyalty point additions, subtractions, amounts to reach another level or acquire another product or service, and other loyalty account information can be inserted in the authorization response messages. The information in the authorization response message can be read and used by the merchant and/or printed on the consumer's credit card receipt. The customer can be apprised of his point balance not only by the receipt from the store but also by the message on his or her cellular phone.

Different types of points are selectable in some embodiments' loyalty programs. For example, frequent flier miles, reward credits, and cash back bonuses are types of points. In response to the loyalty point information message on his or her phone after a transaction, a consumer can select a different type of points to earn in his or her next transaction. For example, after a consumer has acquired 25,000 frequent flyer miles in a bank's loyalty program, the consumer can switch to earning cash back points in the same loyalty account. The 25,000 frequent flyer mile balance stays so that the consumer can purchase an airline ticket sometime in the future, while cash back points are accrued in a different balance in the same account.

With cell phone notification, a consumer can instantly be presented with a coupon for an additional purchase using the points he or she has accumulated. In some embodiments, the consumer can select, using a touch screen on his or her mobile device, which coupon to accept. The consumer can then tender the coupon for an additional purchase at the store in which the first transaction was made.

Returned merchandise can instantly decrease the number of points accrued in some embodiments. The deduction of points can be relayed not only through an authorization response messages to the receipt but also through a text message to the consumer's cellular phone. The consumer can then know exactly how many points he or she has after a return.

An “authorization request message” includes an electronic message that complies with International Standards Organization (ISO) specification ISO 8583 for point-of-sale (POS) terminals, automated teller machines (ATMs), and other payment systems. An authorization request message also includes those that comply with other standards and specifications and/or be formalized in their format, length, and/or meaning. An authorization request message is typically sent by a credit, debit, or other card reader at a store to the store's bank. The message, or components thereof, is further routed to the cardholder's bank for approval. In response to the authorization request message is an authorization response message.

An “authorization response message” includes an electronic message that complies with ISO 8583 and/or other formal or informal standards for format and meaning. An authorization response message also includes those that comply with bilateral standards and specifications between specific companies and/or be formalized in their format, length, and/or meaning. An ISO 8583 authorization response message is typically sent from an issuer bank and indicates whether or not a cardholder has enough credit associated with his or her account to make a particular purchase that is requested. The message, in one form or another, is routed back to the source of the message, typically a POS terminal, card reader, cash register, or other check out device.

A length of an authorization response message can be fixed or it can have expandable fields. A Tag Length Value (TLV) format can be used to deliver payment and authentication data, providing flexibility and usage of standard or new payment and authorization message fields. A TLV format can include tag (position number), length, data, and other fields.

Authorization request and response messages can be initiated for transactions that involve physical cards or other indicators of accounts, such as devices that display or store account numbers.

A “transaction” can include a purchase, return, exchange, online or in-person, or other operation conducted with a merchant.

A “merchant” can include a merchant as defined by the Uniform Commercial Code (UCC) or other sellers or buyers. A merchant can include online merchants as well as local brick-and-mortar based merchants, in addition to others.

A “mobile device” can include cellular phones, such as touch screen smart phones, pagers, portable game machines, networked digital cameras, and other portable electronic devices.

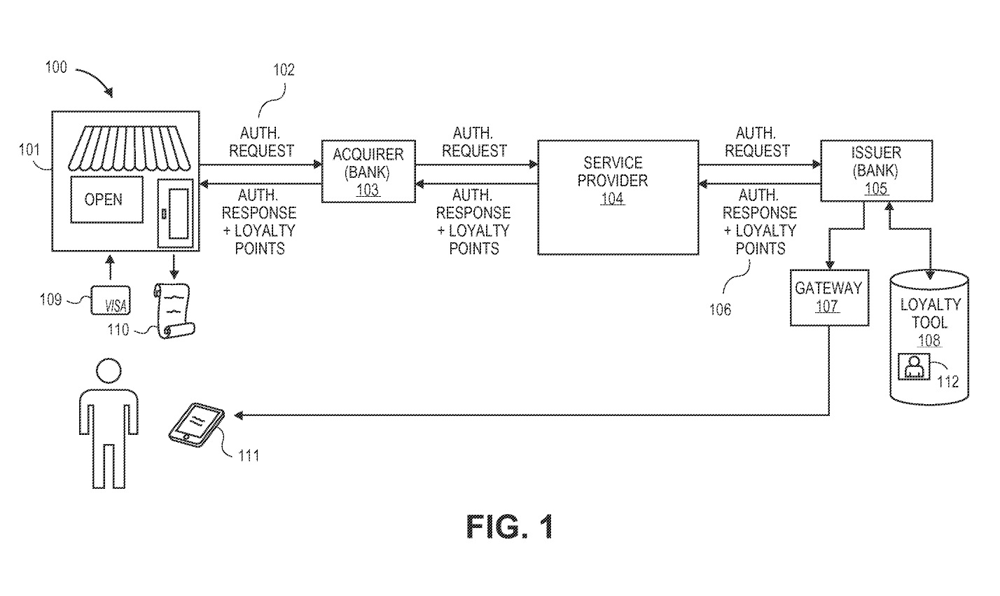

FIG. 1 illustrates an issuer-sponsored loyalty program and electronic messaging in accordance with an embodiment. Messaging 100 is initiated with a purchase by a customer from merchant 101. The customer uses payment card 109 to pay for the purchase. A POS terminal within the store sends authorization request message 102 to the merchant's bank, acquirer 103. In other embodiments, the acquirer can be a different type of financial institution than a bank. The authorization request message, or parts thereof making up an authorization request message, is routed to service provider 104, which in turn routes the authorization request message to the customer's bank, issuer 105.

In the exemplary embodiment, issuer 105 sponsors a customer loyalty program. The customer loyalty program is managed through loyalty tool 108 that accesses a database that stores account information 112 for the customer. The issuer uses the purchase amount in the authorization request message to update the customer's point balance. For example, if the customer is purchasing a $250 worth of merchandise and each dollar gives one-tenth of a loyalty point, then the balance of the customer's loyalty program account is increased by 25 points.

The amount of points earned and the newly calculated balance are inserted into authorization response message 106 and sent back from issuer 105 to service provider 104. The authorization response message indicating the updated account balance is sent back to acquire 103, where it is forwarded back to merchant 101.

At merchant 101, a receipt printer prints receipt 110 for the transaction with the new balance of loyalty points at the bottom of the receipt underneath the tax and total information.

While the authorization response message is being forwarded back from issuer 105 to merchant 101, issuer 105 creates an electronic message detailing the amount of loyalty points earned in the transaction and the new balance in the loyalty account. Issuer 105 sends the electronic message through gateway 107 to the user's telephone number on file to smart phone 111. The electronic message tells the user exactly how many points that he or she possesses now that the new purchase was made.

The electronic message also can have the last four digits of the account or card number. In an account with multiple users, such as one having a primary account holder and one or more authorized account users, a primary account holder may be participating in the loyalty program and have a mobile device registered for the alerts. However, in some embodiments the registered mobile device will receive an alert even if an authorized user performs a transaction. The last four digits of the account number, which are customarily different among the primary account and authorized accounts, indicate the particular authorized user who performed the transaction. Alternatively or in addition, the name of the authorized user corresponding to the last four digits of the account number can be placed in the electronic message.

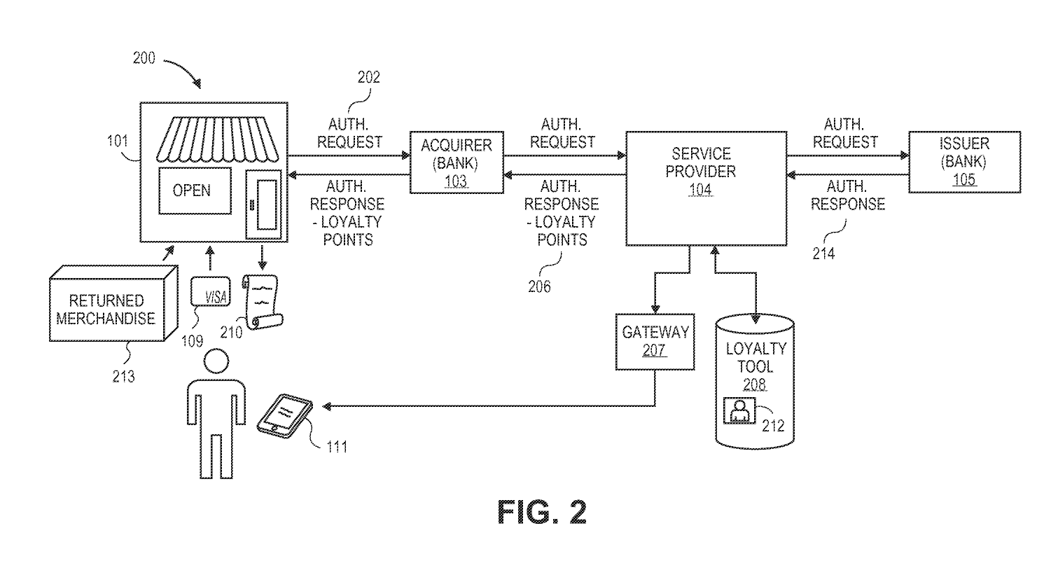

FIG. 2 illustrates a service provider-sponsored loyalty program and electronic messaging in accordance with an embodiment. Messaging 200 is initiated with a return of merchandise 213 by a customer to merchant 101. The customer offers payment card 109 for the vehicle to receive money back. A POS terminal within the store sends authorization request message 202 (with a 40× field) to the merchant's bank, acquirer 103. The authorization request message, or parts thereof as the message, are routed to service provider 104, which in turn routes the authorization request message to the customer's bank, issuer 105. Issuer checks the customer's bank account to ensure it is still open, among other things, and sends authorization response message 214 back to service provider 104.

In the exemplary embodiment, service provider 104 sponsors a customer loyalty program. The customer loyalty program is managed through loyalty tool 208 that accesses a database that stores account information 212 for the customer. The issuer uses the return amount in the authorization request message to update the customer's point balance. For example, if the customer is returning merchandise worth $250 and each dollar is worth one-tenth of a loyalty point, then the balance of the customer's loyalty program account is decreased by 25 points.

The amount of points is deducted and the new balance are inserted into authorization response message 214 to make authorization response message 206. The authorization response message is sent back from service provider 104 to acquirer 103, where it is forwarded back to merchant 101.

At merchant 101, a receipt printer prints receipt 210 for the transaction with the new balance of loyalty points at the bottom.

While the authorization response message is being forwarded back to merchant 101, service provider 104 creates an electronic message detailing the amount of loyalty points deducted in the transaction as well as the new balance in the customer's account. The electronic message can also have fields for the last four digits of the corresponding account as well. Service provider 104 sends the electronic message through gateway 207 to the user's mobile device, smart phone 111.

Technical advantages of the above embodiments are many. If points are shown both on a receipt and on a user's mobile device, then the consumer can compare the point totals to ensure their correctness. If the two do not match, then an active element, such as a HyperText Markup Language (HTML) (hyper)link, button, switch, active area on a screen, etc. can be activated to inquire about the discrepancy. In some embodiments, a user may find that the points from a purchase have put him or her over a threshold and, in response, he or she can adjust settings in his consumer loyalty account conveniently using his mobile device. In some embodiments, a user can be apprised that he is about to cross a threshold for a ‘free’ item, level, etc. and thus be encouraged to make an additional purchase.

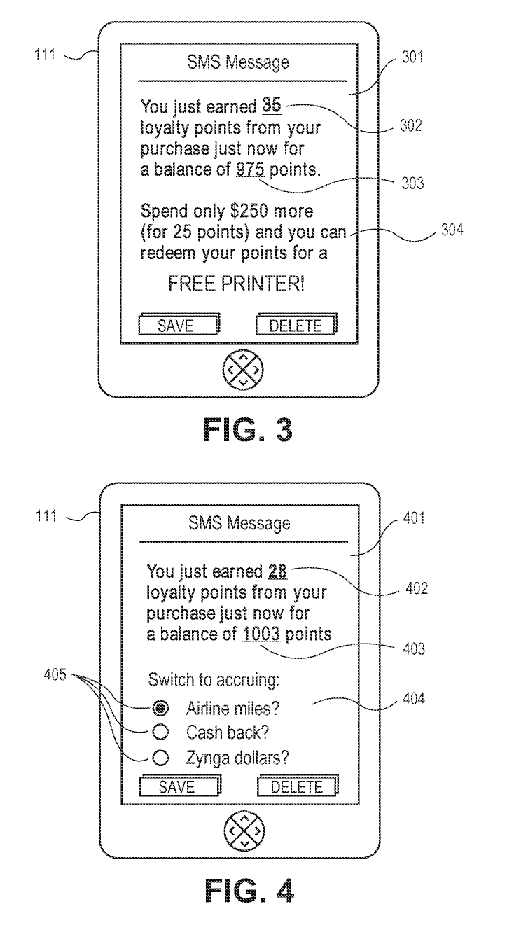

FIG. 3 illustrates an electronic message with information on further loyalty points needed in accordance with an embodiment. Short message service (SMS) message 301 on smart phone 111 includes the change in points from the previous balance, change 302, and the new, current balance of the loyalty points, balance 303.

Message 301 also includes advertisement 304 indicating how many more customer loyalty points are required to redeem the points for a product.

The sending of the message can be based on the respective account balance. For example in some embodiments, no message will be sent unless the consumer's account balance is within 1%, 2%, 5%, 10%, or other fixed percentage of a prize. In some embodiments, the electronic message can be sent only if the user has accumulated enough points to trade them for the lowest level prize. In still other embodiments, a user may configure his or her loyalty account so that the electronic message is sent only after a user-configured amount of points is acquired. For example, a message concerning frequent flier mile points can be configured to only be sent after at least 10,000 miles are acquired.

In some embodiments, the reminders of points may be based on the product that was just purchased or the immediate geographic location of the consumer. For example, if the user has just bought a book at a nationwide bookstore and thus surpassed 10,000 loyalty points in his or her account, then an electronic message can be sent reminding the user that a new book may be acquired from the bookstore for 10,000 points.

FIG. 4 illustrates an electronic message with selections for other types of loyalty points in accordance with an embodiment. Multimedia Messaging Service (MMS) message 401 includes the change in points from the previous balance, change 402, and the new, current balance, balance 403.

Message 401 also includes section 404 indicating that the user can change the type of loyalty credits that he or she accrues for his or her next purchase. In the exemplary embodiment, the user has accrued over 1000 points and now is offered to consider changing to acquiring airline miles, cash back, or non-governmental-issued such as Zynga dollars. The user can buy a bonus product or service using the 1000 loyalty points while concentrating in future purchases on accruing airline miles for a vacation. Radio buttons 405 can be selected by the user to indicate the type of points that the user wishes to receive in future purchases.

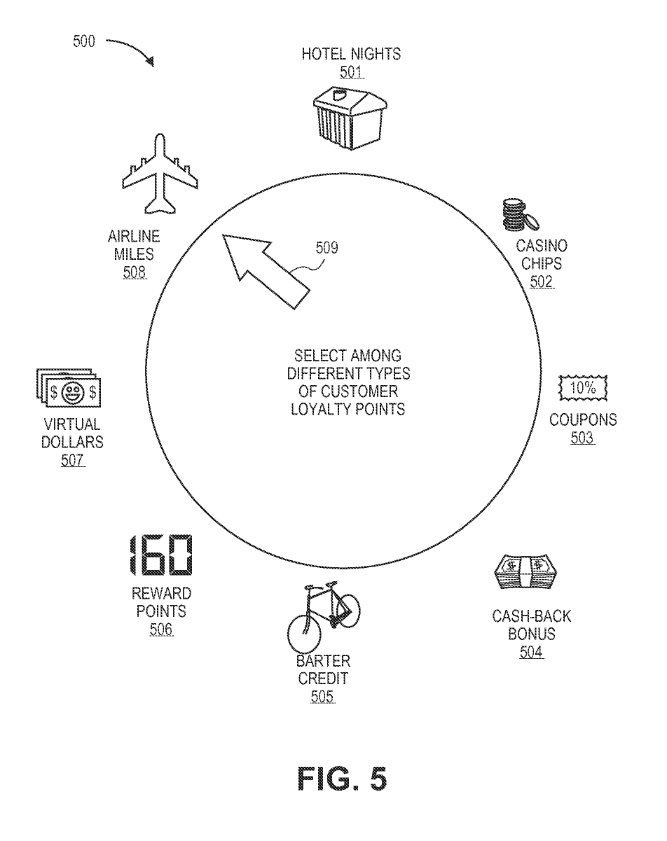

FIG. 5 illustrates types of loyalty points in accordance with an embodiment. Group 500 of types of loyalty points is displayed with selector 509. Hotel nights 501, casino chips 502, coupons 503, cash-back bonuses 504, barter credit 505, reward points 506, virtual dollars 507, and airline miles 508 are selectable. Other types of loyalty points are envisioned. The current selection of selector 509 indicates what type of points are to be accrued next.

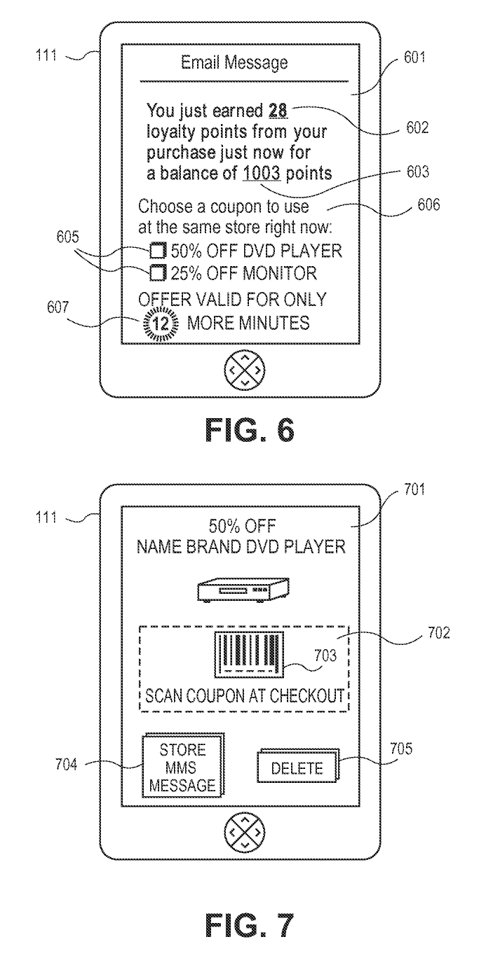

FIG. 6 illustrates an electronic message with selections for a coupon offer in accordance with an embodiment. Email message 601 includes the change in points from the previous balance, change 602, and the new, current balance, balance 603.

Because the user has exceeded 1000 points, the user is offered a choice of coupons to use in section 606. By pressing one of virtual buttons 605 before timer 607 runs out of time, the user can acquire a coupon for use in real-time. In some embodiments, loyalty points are expended to acquire the coupon, and in other embodiments loyalty points are expended only if the coupon is actually used.

FIG. 7 illustrates a coupon in response to a selection on the electronic message of FIG. 6. MMS message 701 includes selected coupon 702 for 50% off a DVD player. The coupon has barcode 703 that can be scanned by a register at checkout. The coupon can be saved by pressing save button 704 or deleted by touching delete button 705.

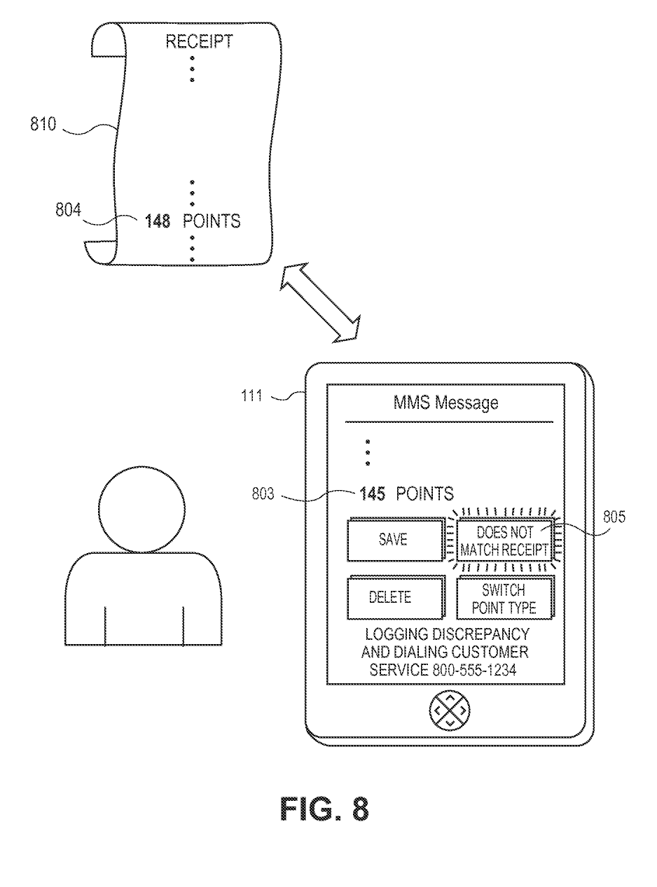

FIG. 8 illustrates a comparison of a receipt and an electronic message in accordance with an embodiment. Receipt 810 shows balance 148 of accumulated loyalty points, which was printed using information from the authorization response message received by the merchant. Mobile device 111 shows an electronic message with balance 803. Balances 803 and 804 do not match.

Upon learning that his or her loyalty program account balances do not match between the receipt and phone message, the user can press soft button 805 to report the discrepancy. Upon pressing the button, the error can be logged and customer service contacted. In this way, customers can help track errors in their own accounts, prevent fraud, or otherwise be more involved in the loyalty program.

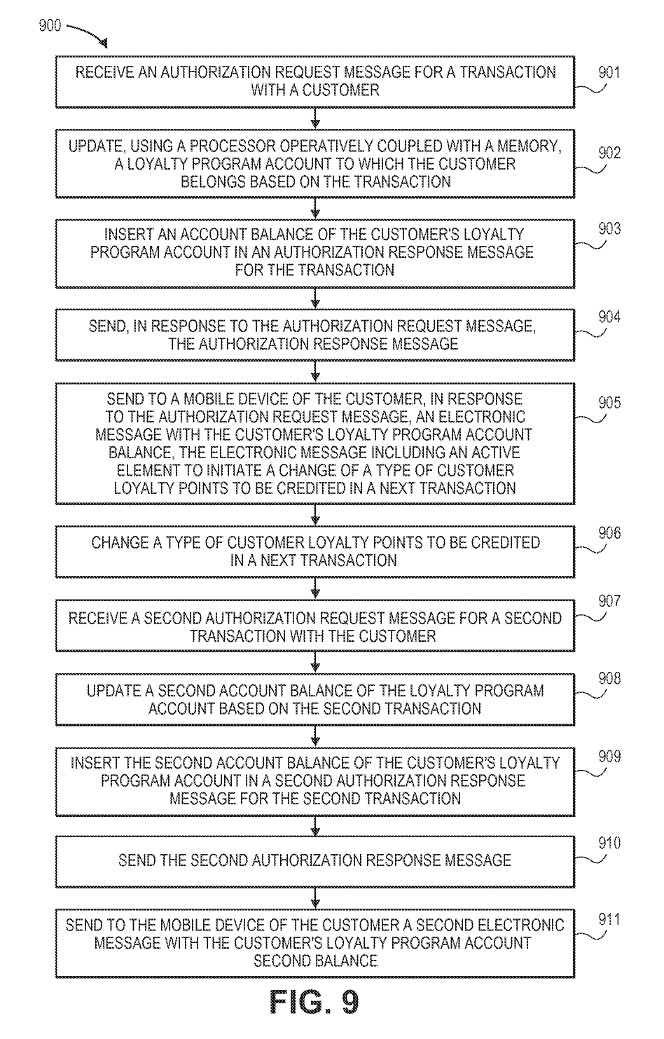

FIG. 9 is a flowchart illustrating a process in accordance with an embodiment. Process 900 includes operations that are optional. In operation 901, an issuer or service provider receives an authorization request message for a transaction with a customer. In operation 902, a loyalty program account to which the customer belongs is updated, using a processor operatively coupled with a memory, based on the transaction. In operation 903, an account balance of the customer's loyalty program account is created with, added, appended, pre-pended, or otherwise inserted in an authorization response message for the transaction. In operation 904, the authorization response message is sent to the merchant in response to the authorization request message. In operation 905, an electronic message with the customer's loyalty program account balance is sent to a mobile device of the customer in response to the authorization request message. The electronic message includes an active element to initiate a change of a type of customer loyalty points to be added or otherwise credited in a next transaction.

In operation 906, a type of customer loyalty points to be credited in a next transaction is changed, such as by setting a flag in a database. In operation 907, the issuer or service provider receives a second authorization request message for a second transaction with the customer. In operation 908, a second account balance of the loyalty program account is updated based on the second transaction. In operation 909, the second account balance of the customer's loyalty program account is inserted in a second authorization response message of the second transaction. In operation 910, the second authorization response message is sent to the merchant. In operation 911, a second electronic message with the customer's loyalty program account second balance is sent to the mobile device of the customer.

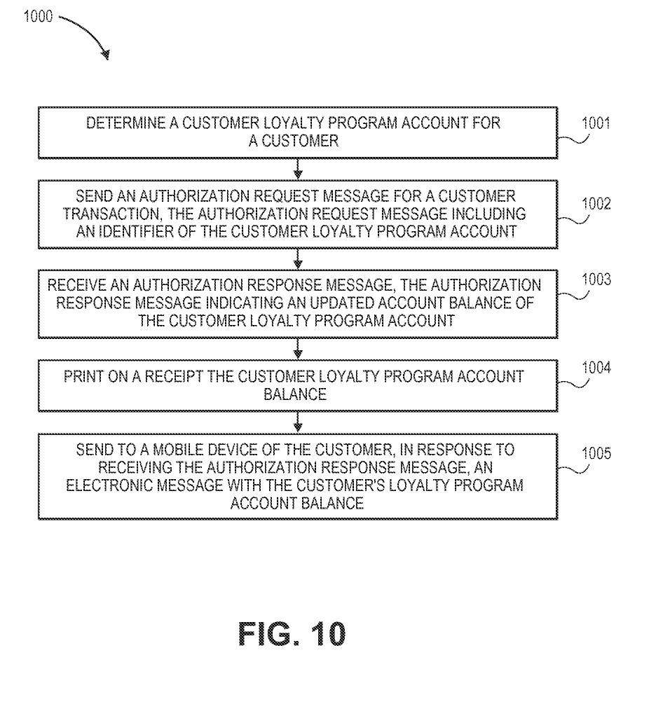

FIG. 10 is a flowchart illustrating a process in accordance with an embodiment. Process 1000 includes operations that are optional. In operation 1001, a merchant determines a customer loyalty program account for a customer, possibly by scanning a loyalty program card offered by the customer. In operation 1002, an authorization request message for a customer transaction is sent to an acquirer, the authorization request message including an identifier of the customer loyalty program account. The identifier can include an X-digit account number of the customer looked up from a database at the merchant's site, the customer's name, or other identifiers. In operation 1003, an authorization response message is received by the merchant. The authorization response message indicates an updated account balance of the customer loyalty program account. In operation 1004, the merchant's cash register prints on a paper or electronic receipt the customer loyalty program account balance. In operation 1005, the merchant sends to a mobile device of the customer, in response to receiving the authorization response message with the updated balance, an electronic message with the customer's loyalty program account balance.

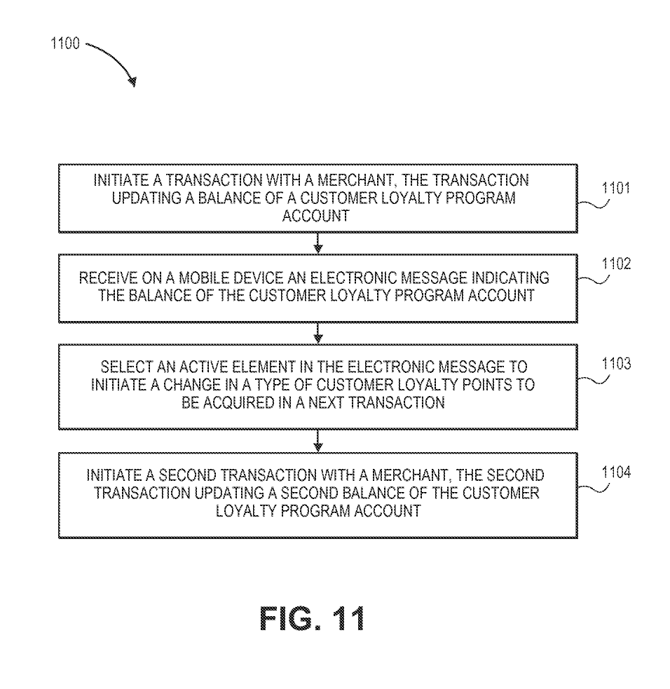

FIG. 11 is a flowchart illustrating a process in accordance with an embodiment. Process 1100 includes operations that are optional. In operation 1101, a user initiates a transaction with a merchant, the transaction updating a balance of a customer loyalty program account for the user. In operation 1102, the user receives on his or her mobile device an electronic message indicating the balance of his or her customer loyalty program account. In operation 1103, the user selects an active element, such as a virtual button, in the electronic message to initiate a change in a type of customer loyalty points to be acquired in a next, future transaction. In operation 1104, the user initiates a second transaction with (the same or another) merchant, the second transaction updating a second balance, corresponding to the new type of loyalty points, of the customer loyalty program account.

Embodiments of the invention are not limited to the above-described embodiments. For example, although separate functional blocks are shown for an issuer, service provider, and acquirer, some entities perform all of these functions and may be included in embodiments of invention.

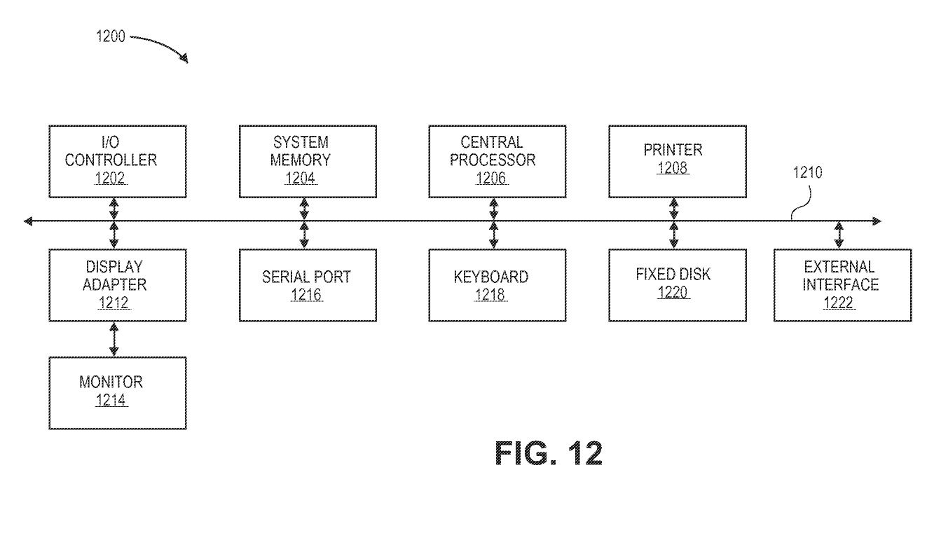

FIG. 12 shows a block diagram of an exemplary computer apparatus that can be used in some embodiments. The subsystems shown in the figure are interconnected via a system bus 1210. Additional subsystems such as a printer 1208, keyboard 1218, fixed disk 1220 (or other memory comprising computer readable media), monitor 1214, which is coupled to display adapter 1212, and others are shown. Peripherals and input/output (I/O) devices, which couple to I/O controller 1202, can be connected to the computer system by any number of means known in the art, such as serial port 1216. For example, serial port 1216 or external interface 1222 can be used to connect the computer apparatus to a wide area network such as the Internet, a mouse input device, or a scanner. The interconnection via system bus allows the central processor 1206 to communicate with each subsystem and to control the execution of instructions from system memory 1204 or the fixed disk 1220, as well as the exchange of information between subsystems. The system memory 1204 and/or the fixed disk 1220 may embody a tangible computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method of providing real-time loyalty balances to customers, the method comprising:
receiving an authorization request message for a transaction with a customer;
updating, using a processor operatively coupled with a memory, a loyalty program account to which the customer belongs based on the transaction;
inserting an account balance of the customer's loyalty program account in an authorization response message for the transaction;
sending, in response to the authorization request message, the authorization response message; and
sending, in response to the authorization request message, to a mobile device of the customer an electronic message with the customer's loyalty program account balance.

2. The method of claim 1 wherein the electronic message includes an active element to initiate a change of a type of customer loyalty points to be credited in a next transaction.

3. The method of claim 2 wherein the active element comprises a hyperlink or button.

4. The method of claim 2 wherein the type of customer loyalty points is selected from the group consisting of airline miles, reward points, a cash-back bonus, and non-governmental-issued currency.

5. The method of claim 2 further comprising:
changing a type of customer loyalty points to be credited in a next transaction; and then
receiving a second authorization request message for a second transaction with the customer;
updating a second account balance of the loyalty program account based on the second transaction;
inserting the second account balance of the customer's loyalty program account in a second authorization response message for the second transaction;
sending the second authorization response message; and
sending to the mobile device of the customer a second electronic message with the customer's loyalty program account second balance.

6. The method of claim 1 wherein the sending to a mobile device of the customer the electronic message is based upon the account balance of the customer's loyalty program account.

7. The method of claim 1 wherein the authorization request message is for credit for returned merchandise and the updating of the loyalty program account includes deducting benefits from the customer's loyalty program account.

8. The method of claim 1 wherein the electronic message includes an advertisement, the advertisement indicating how many more customer loyalty points are required to redeem the points for a product or service.

9. The method of claim 1 wherein the electronic message comprises an amount of the update.

10. The method of claim 1 wherein the message is in a format selected from the group consisting of a short message service (SMS) text message, a multimedia messaging service (MMS) message, email, and instant message.

11. The method of claim 1 wherein the operations are performed in the order shown.

12. The method of claim 1 wherein each operation is performed by the processor operatively coupled with the memory.

13. A machine-readable tangible storage medium embodying information indicative of instructions for causing one or more machines to perform the operations of claim 1.

14. A computer system executing instructions in a computer program, the computer program instructions comprising program code for performing the operations of claim 1.

15. A method of providing real-time loyalty balances to customers, the method comprising:
determining a customer loyalty program account for a customer;
sending an authorization request message for a customer transaction, the authorization request message including an identifier of the customer loyalty program account;
receiving an authorization response message, the authorization response message indicating an updated account balance of the customer loyalty program account;
printing on a receipt the customer loyalty program account balance; and
sending, in response to receiving the authorization response message, to a mobile device of the customer an electronic message with the customer's loyalty program account balance.

16. The method of claim 15 wherein the electronic message includes an active element to initiate a change of a type of customer loyalty points to be credited in a next transaction.

17. The method of claim 15 further comprising:
sending to the mobile device of the customer an electronic message with an advertisement, the advertisement indicating how many more customer loyalty points are required to redeem the points for a product or service.

18. A method of changing a type of consumer loyalty points, the method comprising:
initiating a transaction with a merchant, the transaction updating a balance of a customer loyalty program account;
receiving on a mobile device an electronic message indicating the balance of the customer loyalty program account; and
selecting an active element in the electronic message to initiate a change in a type of customer loyalty points to be acquired in a next transaction.

19. The method of claim 18 further comprising:
initiating a second transaction with a merchant, the second transaction updating a second balance of the customer loyalty program account.

20. The method of claim 18 further comprising:
comparing a balance of the customer loyalty program account printed on the receipt with a balance of the customer loyalty program account in the electronic message; and
performing further action based on the comparison.
